(19) United States
(12) Patent Application Publication
(10) Pub. No.: US 2020/0178718 A1
(43) Pub. Date: Jun. 11, 2020

(54) Process for Producing Printed Solid Objects

(71) Applicant: Jerry Surber, Madisonville, TX (US)

(72) Inventor: Jerry Surber, Madisonville, TX (US)

(21) Appl. No.: 16/790,192

(22) Filed: Feb. 13, 2020

Related U.S. Application Data
(63) Continuation-in-part of application No. 15/728,222, filed on Oct. 9, 2017.
Application No. 15/728,222 is a continuation of application No. 15/272,351, filed on Sep. 21, 2016, now abandoned.
(60) Provisional application No. 62/213,023, filed on Sep. 1, 2015.

(51) Int. Cl. A47G 33/00; B41M 5/00; B41J 2/01; B44C 1/17

(52) U.S. Cl. CPC A47G 33/004; B41M 5/0076; B41M 5/0052; B41J 2/01; B44C 1/1712; B41M 5/0047

(57) ABSTRACT

A process for printing the surface of objects such as trophies and plaques including the steps of a) providing a sheet(s) or block(s) of desired shape having surface(s) and edges; b) laminating at least one surface of the objects with heat transfer foil to provide a clear, white or shade of white polymer coating; and optionally, c) printing a design onto the shade of white coating on the surface of the object by UV printing or sublimation printing. Trophies and plaques made by the process. It is also the objects so laminated and/or printed.

### CROSS REFERENCE TO RELATED APPLICATIONS

This application is a continuation-in-part of U.S. patent application Ser. No. 15/728,222 filed Oct. 9, 2017 which is a continuation in part of U.S. patent application Ser. No. 15/272,351 filed Sep. 21, 2016, which claims benefit of Provisional Patent Application Ser. No. 62/213,023 filed Sep. 1, 2015, the contents and disclosure of which is incorporated herein by reference in its entirety for all purposes.

### BACKGROUND

### Field of the Invention

The invention pertains to manufacture and printing of wooden plaques and trophies.

### Background

Wooden trophies typically are not printed. Graphics and other information are printed on separate sheets or metal plates and attached to the wooden trophy with adhesive. This makes the trophies and plaques relatively expensive, necessarily relatively small, not easily adaptable to customization in small batches, and lacking in the aesthetic appearance of having graphics printed directly on the trophy or plaque surface. Most hand-painted trophies typically made in China, are constructed of a polymer resin material using acold-casting process. These lack the quality look and feel of wooden trophies and plaques.

What is needed is an inexpensive easily customizable means to provide quality wooden trophies and plaques that include graphics and information directly printed onto the wooded surface. The present invention is such a means.

### BRIEF SUMMARY OF THE INVENTION

The invention is, therefore, a process for printing the surface of wooden trophies comprising:
a) cutting wooden sheet(s) or block(s) to desired shape to provide pieces with surface(s) and edges;
b) laminating at least one surface of the cut piece with heat transfer foil (film) having no printing to provide a clear, white or shade of white coating;
c) printing a design onto the shade of white, white shade, or clear foil (film) on the surface of the piece by UV printing or sublimation printing.

It is also trophies and plaques made by the process.

### DESCRIPTION OF THE DRAWINGS

FIG. 1 is a flow diagram of the process an embodiment of the invention.

FIGS. 2-A, 2B, and 2C are drawings of wooden trophies made by an embodiment of the invention.

FIG. 3 consists of drawings of large wooden plaques made by an embodiment of the invention.

FIG. 4 is a drawing of a stacked trophy with wooded risers.

### DETAILED DESCRIPTION

In broad aspect, the invention is a process for improved UV or sublimation printing on solid objects by preparing the surface of the object to be printed with a clear, white, or white shade polymer unprinted coating of a heat transfer polymer foil (or film). The invention is also the object so prepared and optionally printed. In one embodiment, the clear, white, or white shade coating is a heat transfer polyester polymer foil (film). Polyester, polymer-coated substrates are especially suitable for sublimation printing because they enable prepared objects to be customized by smaller local dealers or distributors. Examples of the invention process are illustrated in the printing of wooden plaques and trophies and are equally applicable to other solid objects that are to be printed.

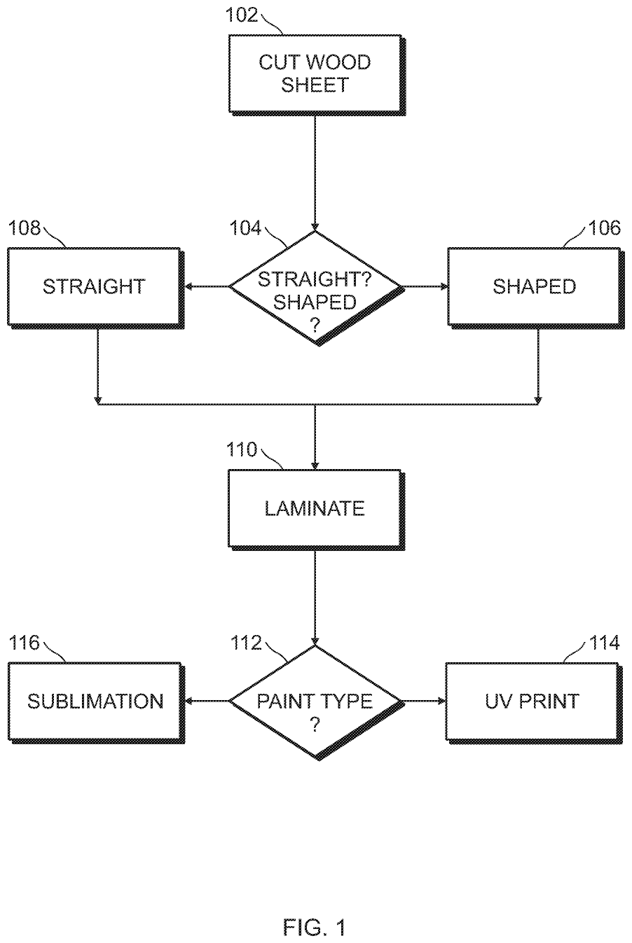

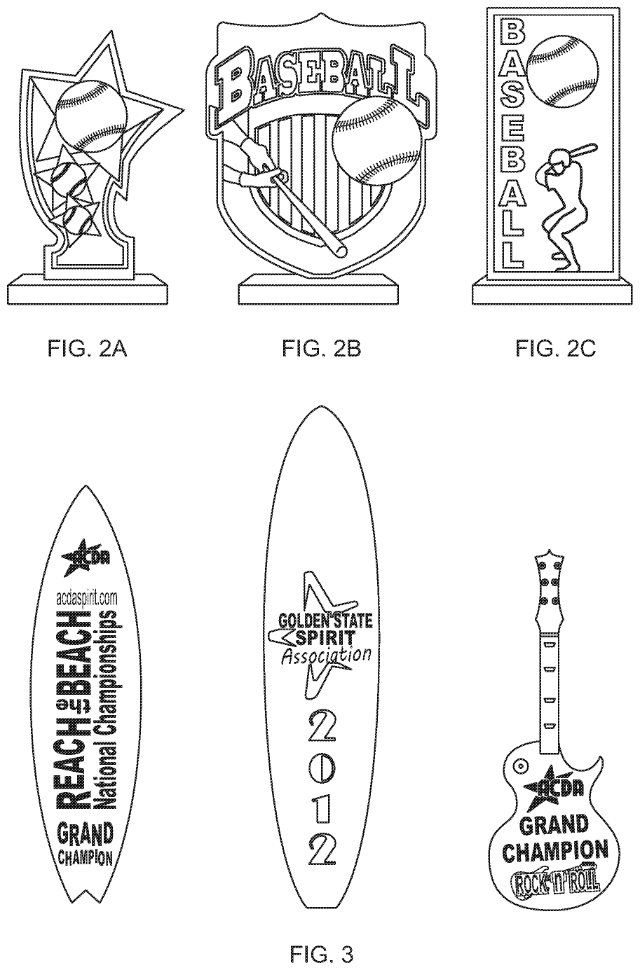

Referring to FIG. 1, flat wooden stock (or stock of other materials) of medium density fiberboard (MDF) sheet stock is cut into pieces (102). While many hardwoods are suitable for use in the process of the invention, MDF is a customary material for trophies and plaques and is preferred. MDF is especially suitable as it is relatively inexpensive, dimensionally stable, and has a very consistent surface for printing. See article at en.wikipedia.org/wiki/Medium-density-_fibreboard.Plaques and flat trophies are generally made from a ½-inch to one-inch thick sheet, with ⅜-inch thickness being most common. Blocks of MDF (or other wood) can also be used to make three-dimensional (block) trophies by the same process. After cutting the sheet(s) (or block) to the desired shape, it is determined (104) if the finished piece is to be straight-edged (as illustrated in FIG. 2C) or shaped (as illustrated in FIGS. 2A and 2B). If shaped, then the edges are painted and if straight, the edges can be laminated in the same manner as the surface is laminated (110) as described below. Painting the edges requires the following process: painting, sanding, repainting, re-sanding and repainting until a suitably smooth finish is achieved. This process is much more time consuming and expensive than simply laminating with heat transfer foil (film) which will provide a smooth finish suitable for further printing in a single step and at less cost. For painting, it is preferred to use an oil-based lacquer such as Black Lacquer Sealer, available from Gemini Coating, Inc. (information available at www.gemini-coatings.com). Black is the preferred and customary color used on edges of plaques and trophies; however, any color is within the scope of the process of the invention. Block trophies may have at least one printed side surface (on white coating) and one other side in any other color or pattern.

Shaped pieces are suitably constructed into a desired shape using a computer navigated control router (CNC). Such routers are well known and are widely commercially available.

The surface of the pieces (optionally with the edges finished) are then laminated with an unprinted heat transfer foil (110) to leave a clear, white, or shade of white polymer coating on the surface. By unprinted is meant that no pattern is printed on the foil, only the white shades of color. This foil laminated on the surface of the object makes an excellent surface o for printing that is clearer than printed on pained surfaces. Suitable laminating machines are commercially available. These machines consist of hot roll laminators that bond pre-glued papers, transfer foils, and other heat-sensitive materials onto substrates such as particleboard, MDF, other sheet stock, or other webs of material. Rollers (or a rubber conveyor belt) carry the substrate into the machine and under the nip of each roller where heat and pressure securely bond the laminate. Machines with silicone rollers are preferred for the process of this invention. Machines sold by Fletcher Machine Industries, Inc. of Lexington, N.C. are used successfully.

In general, heat transfer foil (sometime called film) consists of a carrying film, a coating film (sometimes called ink) that is to be transferred to another substrate by heat and pressure, and a heat-activated adhesive layer. When the film is placed on a substrate and heat and pressure are applied, the coating is transferred from the film to the substrate and held in place by the adhesive. The carrying film is then discarded. The foil of this invention is unprinted (but colored) prior to laminating onto the object to be used. This unlike those systems where printed coating and foil or films are laminated on the object surface. Preprinted foil would defeat the purpose of the present invention.

Heat transfer film that is suitable for the process of this invention has a polymer coating (layer, coating, or ink) printed on a polymer carrying film and is coated with an adhesive layer. Polymers that can be made into carrying film typically include PVC (vinyl) PET, Polyurethane, and polyesters. Other polymers that can be made into film and coated are also suitable. The white, white shade, or clear coating layers useful for this invention are those that, when heat is transferred to the object substrate, form the base on which designs and lettering and the like can be printed by UV or sublimation printing. Polymer coating compositions (inks), typically used for coating wood grain and marble patterns, are suitable for use on substrates that are to be printed by UV printing. Polyester coating is especially suitable and is required for sublimation printing per the process of this invention.

An especially suitable film was custom-made to accept dye sublimation inks for a demonstration of the process of this invention. The film (foil) is a clear polymer on which is printed a polyester clear coat, then a white coat, and finally a coat of adhesive, so that when used to laminate onto a substrate, there will be a clear polyester coat on top of a white coat on the substrate of the object to better accept dye sublimation ink. In custom heat transfer film, the polyester clear coat and white coat are mixed.

As discussed above applying a polymer clear or white coating with heat transfer foil (film) provides a better surface finish than painting with water or oil-based paints and is much more cost effective. The coating is applied to the substrate surface by a laminating machine that applies heat (typically about 300° F.), and elastomeric (usually silicone) rollers that apply a heat transfer surface coat (customarily a graphic such as a wood grain, marble background).

In the process of the invention, the coat that is transferred to the surface of the piece is clear, white, or near white (shaded of white). This is unlike the customary coating in the industry that uses laminating coating to apply background patterns to the surface of the piece (patterns such as a wood grain look, a marble look, and the like). The use of a clear, white, or shade of white, while unknown in the industry, provides a much better base on which to print a suitable customer-specific graphic in the next step (114 or 116) of the process. “Shades of white are colors that differ only slightly from pure white. Variations of white include what are commonly termed off-white colors, which may be considered part of a neutral color scheme. Colors often considered “shades of white” include, cream, eggshell, ivory, Navajo white, and vanilla. Even the lighting of a room, however, can cause a pure white to be perceived as off-white.” Seeen.wikipedia.org/wiki/Shades_of_white. Clear coating means transparent or “sufficiently” opaque and allows shapes to be easily discernable through the film in ambient light. A patterned or color-based coating would not be suitable for printing, according to the process of the invention.

As used herein, “substrate” is defined as the surface of the object to be printed. An applicable dictionary definition is: “the material on which a process is conducted.”

With the surface laminated with white or near white foil, the piece is then printed by UV printing (114) or sublimation printing (116). Blocks of wood used to make three-dimensional block trophies are constructed in the same manner, and the surface of the edges can also be printed. With UV printing slightly three-dimensional (textured or sculptured) objects of up to about 4 mm differentiation (top of surface to bottom of pattern) can be printed. An advantage of this process is that it enables the production of much larger plaques and trophies than conventional means. FIG. 3 illustrates larger plaques made by the process. The skateboard plaque as shown is about 42-inches high and the guitar plaque, about 36-inches. This process provides a unique, much brighter, and better-defined print that can be easily adapted to small runs of pieces, and thus customized to the individual customer. Ultimately, the process of this invention provides a better, more flexible and cost-effective means for the manufacture of printed wood plaques and trophies.

The coating is applied to the substrate surface by a laminating machine that applies heat (typically about 300° F.), and elastomeric (usually silicone) rollers that apply the heat transfer surface coat (customarily a graphic such as a wood grain, marble background).

Gloss finish coating is preferred, as matte finishes have been found to yellow with age. Thus, matte finishes made from heat-transfer paper are inferior to those produced by a heat-transfer polyester gloss coat. As discussed above, there is a need for prepared objects such as trophies and plaques that are ready for sublimation printing. They allow the object to be prepared on a large scale, which is needed as the equipment is expensive, but also customized on site in small and individual batches by dealers and local distributors. In addition, as previously mentioned, coating for acceptable sublimation printing should be polyester polymer clear, white, or while shade coatings.

As used herein, “trophies” refers to structures used for recognition, for participation, or achievement in an event as well as wooden sculptures including tangible structures having at least one relatively flat surface suitable for printing. “Plaques” as used herein means fairly flat wooden structures that are relatively thin (for example about ¼ to 2 inch thickness) and have at least one surface that can be printed, and includes award plaques, placards, signboards, decorative wall decorations, and the like. “Plaques” also include signs, decorative banners, placards, and billboards.

“Flatbed UV Digital (“UV” printed as used herein) printing is the reproduction of digital images using inkjet printing, typically on plastic or paperboard, although a wide variety of materials can be printed (common, photographic paper, film, cloth, plastic, etc.). Flatbed digital printers use inks made of acrylic monomers that are then exposed to strong UV-light to cure, or polymerize them . . . . Environmentally, flatbed UV digital printing is based on a more sustainable system than its commercial predecessor of solvent printing as it produces fewer waste cartridges and less indoor air pollution.” See article in Wikipedia at en.wikipedia.org/wiki/Flatbed_digital_printer. Flatbed UV printing allows computer-generated designs to be printed, thus making small number and customized trophies or plaques very economical. However, flatbed UV printers are relatively expensive and are not generally practical for use by small dealers and distributors.

“Dye-sublimation printing is a digital printing technology using full color artwork that works with polyester and polymer-coated substrates. The result of the sublimation process is a nearly permanent, high resolution, full color print. Because the dyes are infused into the substrate at the molecular level, rather than applied at a topical level (such as with screen printing and direct to garment printing), the prints will not crack, fade or peel from the substrate under normal conditions.” See article in wikipedia at en.wikipedia.org/wiki/Dye-sublimation printer. Sublimation printing equipment is relatively inexpensive and can thus be used by many local dealers and distributors.

In other embodiments, the invention is solid objects such as trophies and plaques printed by the processes as described above.

Objects made from blocks of wood or MDF may be printed on one or more side surfaces and may have a design printed on one surface and a laminated coating of any color or pattern on the other side substrate surfaces. Prototype trophies made by the process of this invention are illustrated in FIGS. 2 A, B, and C. All three were constructed from ⅜-inch MDF, cut to shape, and laminated to provide a white surface coating. The designs as shown were then printed on the clear or white foil coated surface by UV printing. Such trophies may be mounted on suitable bases that allow them to stand upright.

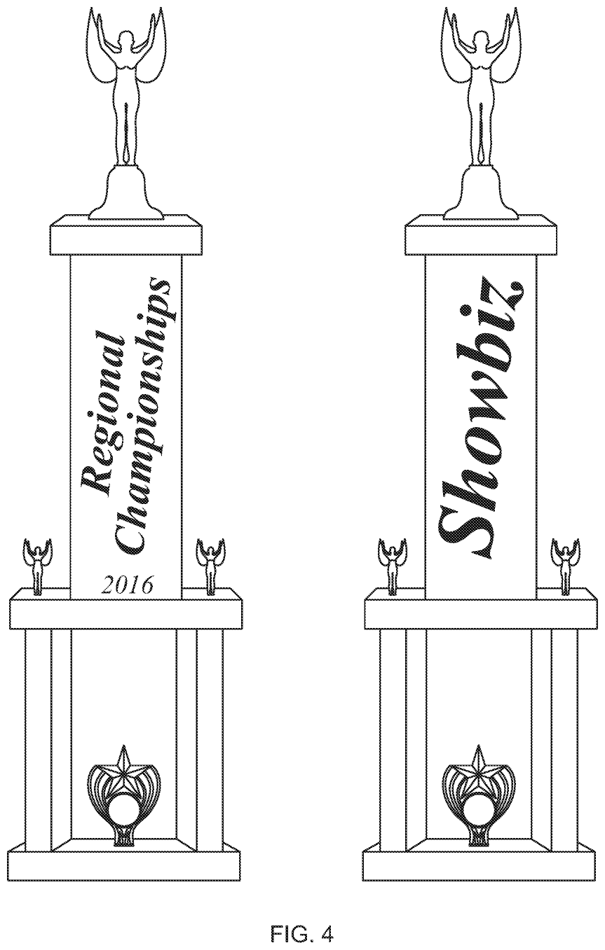

Trophies and other objects may be shaped in any manner so long as there is one surface that is printable according to the process of the invention. For example, trophies may have a shaped top section, shaped sides and/or back. In general, block trophies will have a greater ratio of side width to front (or rear) width than plaques. To illustrate, a block trophy will typically have a front surface of at least two (2)-inch width and a side of at least about 1-inch. For blocks with wider front surfaces, the side will generally be at least about one-quarter (¼) of the width of the front. Block trophies may have a base (wood or marble is preferred), a lid (wood or marble preferred), and may also have a figurine or a riser and figurine attached to the top. FIG. 4 illustrates trophies with a marble base, two wooden risers, a lid, and an additional larger printed riser with a marble lid and a figurine on top. The wooden riser(s) are printed according to the process of this invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A solid object configured for decoration by dye-sublimation printing, comprising:
a) a solid object of a desired shape comprising at least one wooden component, wherein: (i) the wooden component is selected from the group consisting of wooden trophies, wooden plagues, wooden trophy components, wooden plague components, and any combination thereof, (ii) the solid object comprises at least one desired imaging surface and at least one edge and (iii) the desired imaging surface comprises a wooden surface; and
b) a heat transfer film laminated directly onto, and entirely covering, at least the desired imaging surface, wherein: (i) the heat transfer film comprises a multilayer sheet of polyester polymer coating placed on the desired imaging surface and attached by heating and configured suitable for receiving thereunto at least one decoration by sublimation printing, (ii) the polyester polymer coating comprises an outermost surf ace of the desired imaging surface, and (iii) the polyester polymer coating is at least partially a white or shade of white color chosen to
provide sufficient contrast to distinctly distinguish the decoration from the desired imaging surface.

2. The solid object of claim 1 wherein at least some portion of the edge of the solid object is painted.

3. The solid object of claim 1 wherein the solid object is a trophy riser comprising a wooden sheet between one-half to one (½-1) inch thick and at least some portion of the edge of the solid object is finished with a coating selected from the group consisting of: heat transfer film, paint, and some combination thereof and at least a first end of the trophy riser is configured to be fitted into a trophy base.

4. A UV-ink decorated trophy or plague comprising:
a) a solid object of a desired shape comprising at least one wooden component, wherein: (i) the wooden component is selected from the group consisting of wooden trophies, wooden plagues, wooden trophy components, wooden plague components, and any combination thereof, (ii) the solid object comprises at least one desired imaging having a surface and at least one edge, and (iii) the desired imaging surface comprises a wooden surface;
b) a heat transfer film laminated directly onto at least the entire wooden surface and comprising an outermost printable contrast coating; wherein the heat transfer film comprises a multilayer sheet of polyester polymer coating placed on the desired imaging surface and attached by heating and
c) at least one decoration comprising ink polymerized by ultraviolet light and disposed directly on the contrast; wherein: (1) the contrast coating comprises a polymer coating configured suitable for receiving thereon the decoration by UV printing, and (2) the contrast coating is a white or shade of white color chosen to provide sufficient contrast to distinctly distinguish the decoration from the imaging surface.

5. The trophy or plaque of claim 4 wherein the polymer coating is a polyester polymer.

6. The trophy or plaque of claim 4 wherein the wooden surface is sculptured in a design pattern with depth differentiation of no more than 4 mm.

7. A process for preparing the surface of solid objects for comprising:
a) providing a solid object comprising at least one wooden component selected from the group consisting of wooden trophies, wooden plaques, wooden trophy components, wooden plaque components, and any combination thereof: the solid object having at least one desired imaging surface and at least one edge; and the desired imaging surface comprising a wooden surface; and
h) transforming the desired imaging surface into a printable surface by laminating heat transfer film directly thereunto; the printable polyester coating being; a multilayer sheet of polyester polymer coating to be placed on the desired imaging surface and attached by heating and: (i) suitable for receiving a decoration by at least one of: UV printing, dye-sublimation printing, and any combination thereof, (ii) chosen to provide sufficient contrast to distinctly distinguish the decoration from the imaging surface, and (iii) the outermost coating on at least part of the printable surface;
wherein the process is further a process for decorating a solid object, and comprises a further step:
c) the printable surface is decorated by depositing at least one design directly onto the printable polyester coating by UV printing, such that the decoration comprises ink polymerized by ultraviolet light.

8. The process of claim 7 wherein at least one edge of the solid object is painted.

9. The process of claim 7 wherein the process is further a process for decorating a solid object, and comprises a further step:
c) the printable surface is decorated by imprinting at least one design directly into the printable polyester coating or dye-sublimation printing.

10. The process of claim 7 wherein the heat transfer film comprises a disposable polymer film on which is provided at least: first, the printable polyester coating, and finally an adhesive coat: (2) the heat transfer film is applied to the at least one desired imaging surf ace such that the adhesive coat is closest thereto, and the printable polyester coating is outermost: and (3) the printable polyester coating is chosen to be of sufficient contrast at least by being of a color that is white or shade of white.

11. The process of claim 7 wherein the process is further a process for decorating a solid object, and comprises a further step:
c) the printable surface is decorated by depositing at least one design directly onto the printable polyester coating by UV printing, such that the decoration comprises ink polymerized by ultraviolet light.
